(19) United States
(12) Patent Application Publication
(10) Pub. No.: US 2007/0218330 A1
(43) Pub. Date: Sep. 20, 2007

(54) Fuel Cell System

(75) Inventor: Yoshiaki Naganuma, Aichi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi, Aichi (JP)

(21) Appl. No.: 11/578,111

(22) PCT Filed: Apr. 22, 2005
(86) PCT No.: PCT/JP05/08258

§ 371 Date: Oct. 10, 2006

(30) Foreign Application Priority Data
Apr. 23, 2004 (JP) 2004-128426

(51) Int. Cl. H01M 8/04

(52) U.S. Cl. 429/25; 429/34

(57) ABSTRACT

A fuel cell system capable of estimating fuel gas concentration and/or impurity gas concentration, with a simple configuration, is provided. The fuel cell system has an anode path composed of a supply path 75 for supplying fuel to the anode electrode in a fuel cell stack 20 and a discharge path 76 for discharging the fuel from the anode electrode in the fuel cell stack 20. The fuel gas concentration or impurity gas concentration in the anode path is derived based on the pressure loss in the anode path. The pressure loss can be measured by means of a differential pressure gauge 58 or pressure meter disposed in a piping, thus gas concentration can be estimated with a simple configuration without requiring any special measuring instrument.

### BACKGROUND

The present invention relates to a fuel cell system, and particularly to estimation of fuel gas concentration in a fuel circulating path.

A fuel cell is noted as an environmentally-friendly clean power source. Such a fuel cell generates electricity by means of an electrochemical reaction which is produced using fuel gas such as hydrogen and oxidized gas such as air. It is not that all of the fuel gas introduced into a fuel cell stack reacts with oxygen to produce water vapor, but some of the fuel gas passes through the fuel cell stack directly and is discharged along with the water vapor. If this passed fuel gas is directly released to the air, the fuel gas becomes a waste, thus exhaust from the fuel electrode in the fuel cell stack is circulated and then introduced into the fuel electrode again.

Japanese Patent Application Laid-Open No. 2003-317752 describes that the sound velocity inside the gas in the hydrogen circulating system is obtained and hydrogen gas concentration or impurity gas concentration of the gas is estimated based on the obtained sound velocity. Then, a purge is conducted when the hydrogen flow rate is equal to or lower than a threshold and the abundance of the impurity gas is at least at a threshold, whereby energy efficiency in the fuel cell system is enhanced.

However, in this conventional technology an ultrasonic transmission and reception equipment for measuring the sound velocity is required, and problems such as complexity of the devices, increased costs, and difficulty of maintenance are caused.

### SUMMARY

An object of the present invention therefore is to solve such problems of the conventional technology to provide a fuel cell system capable of estimating fuel gas concentration and/or impurity gas concentration, with a simple configuration.

In order to solve the above problems, a fuel cell system of the present invention is a fuel cell system comprising an anode path composed of a supply path for supplying fuel to an anode electrode in a fuel cell stack and a discharge path for discharging the fuel from the anode electrode in the fuel cell stack, wherein fuel gas concentration or impurity gas concentration in the anode path is derived based on the differential pressure between two predetermined points in the anode path. The differential pressure can be measured by means of a differential pressure gauge or pressure meter disposed in a piping, thus gas concentration can be estimated with a simple configuration without requiring any special measuring instrument.

According to a preferred aspect of the present invention, the abovementioned differential pressure is the differential pressure across a check valve in the anode path, or the differential pressure between two points on either side of the fuel cell stack. For example, since the differential pressure is generated easily before and behind the check valve, the differential pressure can be measured appropriately, thus measurement of the differential pressure before and behind the check valve is excellent because no special structure is required for coping with the occurrence of pressure loss.

According to other preferred aspect of the present invention, exhaust from the anode path is controlled based on the derived fuel gas concentration or impurity gas concentration. In this manner, efficiency and stability of the system can be ensured effectively.

In such a case, when the derived fuel gas concentration is reduced or when the derived impurity gas concentration is increased, a purge may be conducted from the anode path. It is preferred that this purge be performed by opening a shutoff valve inside the anode path.

According to another aspect of the present invention, a condition of an electrolyte in the fuel cell stack is judged based on the derived fuel gas concentration or impurity gas concentration. Accordingly, deterioration of the membrane can be judged even during an operation and maintenance information can be provided promptly to an operator and the like.

According to yet another aspect of the present invention, the anode path includes a circulating path for circulating the fuel discharged from the anode electrode in the fuel cell stack back to the anode electrode.

Another fuel cell system of the present invention is a fuel cell system comprising an anode path composed of a supply path for supplying fuel to an anode electrode in a fuel cell stack and a discharge path for discharging the fuel from the anode electrode in the fuel cell stack, wherein fuel gas concentration or impurity gas concentration in the anode path is derived based on the pressure loss in the anode path. According to this configuration, the pressure loss can be measured by means of a differential pressure gauge or pressure meter disposed in a piping, thus gas concentration can be estimated with a simple configuration without requiring any special measuring instrument.

Moreover, another fuel cell system of the present invention is a fuel cell system comprising an anode path composed of a supply path for supplying fuel to an anode electrode in a fuel cell stack and a discharge path for discharging the fuel from the anode electrode in the fuel cell stack, wherein exhaust from the anode path is controlled based on the pressure loss in the anode path. According to this configuration, in the manner as described above, the pressure loss can be measured with a simple configuration and the exhaust from the anode path is controlled based on this measurement, thus efficiency and stability of the system can be ensured effectively.

Yet another fuel cell system of the present invention is a fuel cell system comprising an anode path composed of a supply path for supplying fuel to an anode electrode in a fuel cell stack and a discharge path for discharging the fuel from the anode electrode in the fuel cell stack, wherein the condition of an electrolyte in the fuel cell stack is judged based on the pressure loss in the anode path. In the manner as described above, the pressure loss can be measured with a simple configuration and the condition of the electrolyte is judged basis on this measurement, thus deterioration of the membrane can be judged even during an operation and maintenance information can be provided promptly to an operator and the like.

In this case, it is preferred that deterioration of the electrolyte in the fuel cell stack be judged based on the speed of increase of the derived impurity gas concentration.

In the above fuel cell system, it is preferred that the pressure loss be derived by measuring the pressure different between before and behind a check valve in the anode path. Since the pressure loss is generated easily before and behind the check valve, the pressure loss can be measured appropriately, thus measurement valve is excellent because no special structure is required for coping with the occurrence of the pressure loss.

As described above, according to the present invention, a fuel cell system capable of estimating fuel gas concentration and/or impurity gas concentration, with a simple configuration, can be provided.

### DESCRIPTION OF THE DRAWINGS

FIG. 1 is a configuration diagram schematically showing a fuel cell system according to an embodiment of the present invention;

FIG. 2 is a flowchart showing a procedure of a process of estimating gas concentration according to the fuel cell system of the embodiment;

FIG. 3 is a flowchart showing a procedure of a process of controlling an exhaust shutoff valve according to the fuel cell system of the embodiment; and

FIG. 4 is a flowchart showing a procedure of a process of judging deterioration of an electrolyte according to the fuel cell system of the embodiment.

### DETAILED DESCRIPTION

Next, an embodiment of the present invention is described with reference to the drawings.

[1. Configuration in a Fuel Cell System]

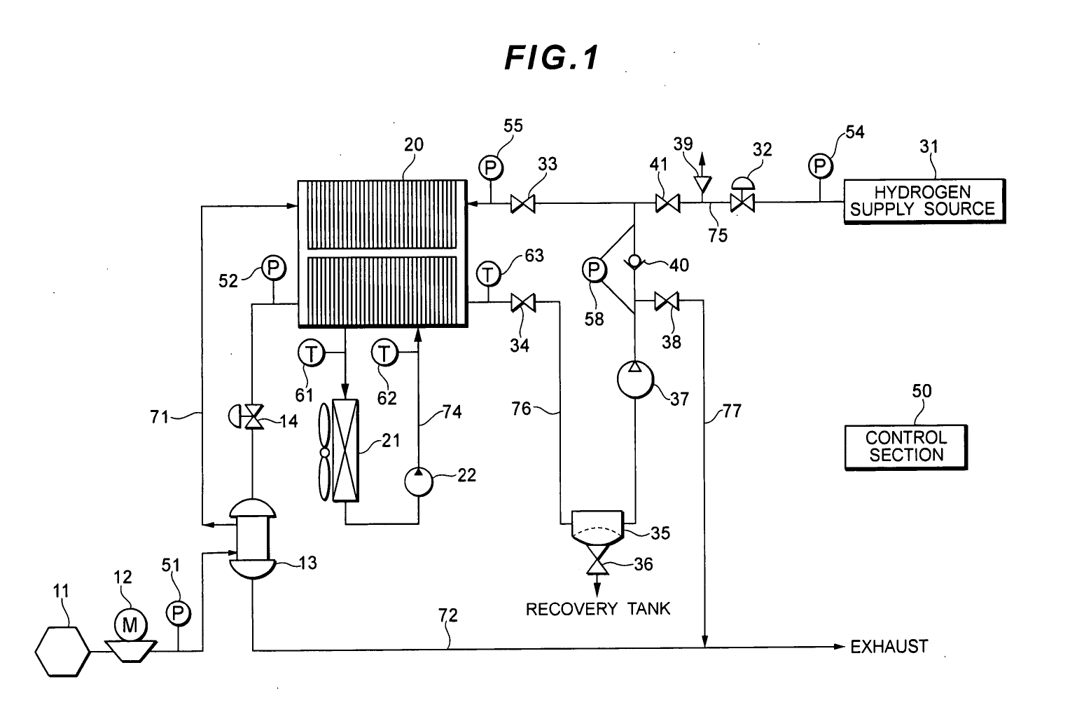

FIG. 1 is a configuration diagram schematically showing a fuel cell system according to an embodiment of the present invention.

As shown in the figure, air (ambient air) as oxidized gas is supplied to an air supply port in a fuel cell stack 20 via an air supply path 71. The air supply path 71 is provided with an air filter 11 for removing microscopic particles from the air, a compressor 12 for pressurizing the air, a pressure sensor 51 for detecting the pressure of the supplied air, and a humidifier 13 for adding required moisture to the air. It should be noted that the air filter is provided with an airflow meter (flow meter) for detecting an air flow rate.

Air off-gas which is discharged from the fuel cell stack 20 is released to the outside via a discharge path 72. The discharge path 72 is provided with a pressure sensor 52 for detecting the pressure of the exhaust air, a pressure-regulating valve 14 and the humidifier 13. The pressure-regulating valve (pressure-reducing valve) 14 functions as a pressure controller for setting the pressure of the air supplied to the fuel cell stack 20. Unshown detection signals from the pressure sensors 51 and 52 are sent to a control section 50. The control section 50 sets the supply air pressure or supply flow rate by adjusting the compressor 12 and the pressure-regulating valve 14.

Hydrogen gas as fuel gas is supplied from a hydrogen supply source 31 to a hydrogen supply port in the fuel cell stack 20 via a fuel supply path 75. The fuel supply path 75 is provided with a pressure sensor 54 for detecting the pressure of the hydrogen supply source, a hydrogen-regulating valve 32 for regulating the pressure of the hydrogen gas supplied to the fuel cell stack 20, a shutoff valve 41, a relief valve 39 which is opened when abnormal pressure occurs in the fuel supply path 75, a shutoff valve 33, and a pressure sensor 55 for detecting input pressure of the hydrogen gas. Unshown detection signals from the pressure sensors 54 and 55 are supplied to the control section 50.

The hydrogen gas which is not consumed in the fuel cell stack 20 is discharged as hydrogen off-gas to a hydrogen circulating path 76 and then returned to a downstream side of the shutoff valve 41 in the fuel supply path 75. The hydrogen circulating path 76 is provided with a temperature sensor 63 for detecting temperature of the hydrogen off-gas, a shutoff valve 34 for controlling discharge of the hydrogen off-gas, a gas-liquid separator 35 for recovering moisture from the hydrogen off-gas, a drain valve 36 for recovering the recovered water into an unshown tank, a hydrogen pump 37 for pressurizing the hydrogen off-gas, and a check valve 40. As means for pressurizing the hydrogen off-gas, an ejector may be used in place of the hydrogen pump 37. Preferably, by providing a differential pressure gauge 58 for measuring the differential pressure across the check valve 40, or pressure sensors provided before and behind the check valve 40 and for measuring the pressure before and behind the check valve 40, the pressure loss (differential pressure) in the hydrogen circulating path 76 is measured, and hydrogen concentration or impurity gas concentration is estimated as described hereinafter. Moreover, in order to obtain gas flow rate in the hydrogen circulating path 76, it is preferred that a flow rate meter be provided at the hydrogen circulating path 76, or counting means for counting the number of rotation of the hydrogen pump 37 be provided. An unshown detection signal from the temperature sensor 63 is supplied to the control section 50. An operation of the hydrogen pump 37 is controlled by the control section 50. The hydrogen off-gas merges with the hydrogen gas at the fuel supply path 75, is then supplied to the fuel cell stack 20, and reused. The check valve 40 prevents the hydrogen gas of the fuel supply path 75 from flowing backward to the hydrogen circulating path 76 side. A line of path, which extends from the hydrogen circulating path 76, passes through the point merging with the fuel supply path 75, and reaches the fuel electrode in the fuel cell stack, is correspond to an anode path of the present invention.

The hydrogen circulating path 76 is connected to the discharge path 72 by a purge flow path 77via an exhaust shutoff valve (purge valve) 38. The exhaust shutoff valve 38 is an electromagnetic shutoff valve, and releases (purges) the hydrogen off-gas to the outside by being activated by a command from the control section 50. By performing this purge operation intermittently, decrease of the cell voltage, which is caused by an increase in the impurity concentration of the hydrogen gas on the fuel electrode side, can be prevented by circulation of the hydrogen off-gas.

Further, a coolant path 74 for circulating cooling water is provided at a cooling water entrance in the fuel cell stack 20. The coolant path 74 is provided with a temperature sensor 61 for detecting temperature of the cooling water discharged from the fuel cell stack 20, a radiator (heat exchanger) 21 for releasing the heat of the cooling water to the outside, a pump 22 for pressurizing and circulating the cooling water, and a temperature sensor 62 for detecting temperature of the cooling water supplied to the fuel cell stack 20.

The control section 50 receives a request load such as an acceleration signal of an unshown vehicle, and control information from each sensor in the fuel cell system, and controls the operations of the various valves and motors. The control section 50 is constituted by a control computer system provided with an unshown arithmetic device and storage device. The control computer system can be constituted by known available systems.

[2. Principle of Estimating Gas Concentration]

Next, the principle of a method of estimating hydrogen gas concentration or impurity gas concentration in the embodiment of the present invention is described.

[2-1. Presupposition]

First, in a steady flow of gas, the pressure loss in the system is proportional to density of the gas. For example, the molecular weight of hydrogen gas as the fuel gas is 2, and the molecular weight of nitrogen gas as the impurity gas is 28, thus, for example, the density and the pressure loss in the 100% nitrogen gas is fourteen times with respect to the 100% of the hydrogen gas.

Next, the gas in the hydrogen circulating system is occupied mostly by hydrogen, nitrogen, and water vapor. The nitrogen is impurity gas which penetrates from the air electrode, and the water vapor is a product generated by an electrochemical reaction between hydrogen and oxygen. It is considered that the amount of the water vapor become substantially saturated vapor (at an outlet in the fuel cell stack).

Therefore, the ratio between the amount of change in the pressure loss and the increase of the nitrogen gas is 1:1, thus the nitrogen gas concentration and the hydrogen gas concentration can be estimated based on the pressure loss.

[2-2. Calculation Method]

Next, a specific example of a calculation method for estimating gas concentration is explained.

When the pressure of saturated vapor at a certain temperature is P_{H2O} and the gas pressure in the system is P_{sys}, the percentage of the water vapor in the system, W_{H2O} (%), is expressed as follows:
W_{H2O}(%)=P_{H2O}/P_{sys}×100(%).

When the pressure loss in the hydrogen gas with 100 % humidity at this temperature (when the nitrogen concentration is 0%) is P_{L1}, and the pressure loss at the hydrogen concentration W_{H2} is P_{L2}, the relationship of is established.
P_{L1}:P_{L2}={W_{H2O}×18+(100−W_{H2O})×2}:{W_{H2O}×18+W_{H2}×2+(100−W_{H2O}−W_{H2})×28}

When this equation is solved, the hydrogen concentration W_{H2} is obtained. It should be noted in the equation that 18 is the molecular weight of water and 100−W_{H2O}−W_{H2} is the nitrogen concentration.

It should be noted that the above calculation is merely an example, and thus the calculation method should not be limited to this example. For example, an attribute map may be created in advance so that the hydrogen gas concentration and the nitrogen gas concentration can be obtained simply by inputting a parameter, and experimental values may be used in stead of calculated values in a method of creating the attribute map.

Moreover, the position and method for measuring the pressure loss (differential pressure) of the fuel off-gas are not particularly limited as long as the measurement is performed in the anode path, thus, for example, an orifice which generates the pressure loss may be provided separately to measure the differential pressure across the orifice. Furthermore, the orifice may be provided at a lower stream from the point where the hydrogen circulating path 76 merges with the fuel supply path 75. However, when ascertaining the pressure loss from the differential pressure between the two points on either side of the fuel cell stack, the pressure loss can be ascertained from as follows:
Pressure loss=Differential pressure−Pressure consumed in the stack, which is computed from the amount of current in the fuel cell,−Cross leakage amount.

[3. Operation of Estimating Gas Concentration]

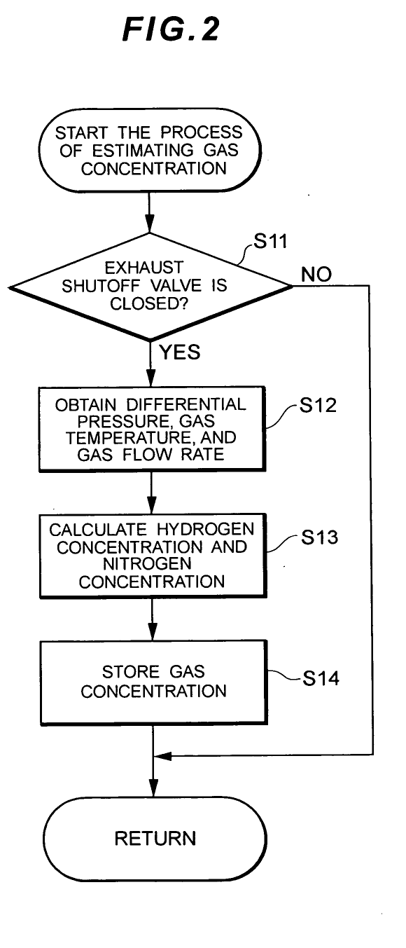

Next, a gas concentration estimation operation performed by the control section 50 in the fuel cell system according to the present embodiment is described with reference to the flowchart shown in FIG. 2. The control section 50 is constituted from a control computer as described above, and executes control of the operation of each part in the fuel cell system in accordance with an unshown control program.

First, whether the exhaust shutoff valve 38 is closed or not is checked (Step 11). When the exhaust shutoff valve 38 is opened (Step 11: NO), it means that hydrogen is being purged, and gas concentration does not have to be estimated, thus the process is returned to wait for the next operation timing. When the exhaust shutoff valve 38 is closed (Step 11: YES), the differential pressure between two predetermined points in the anode path is read from an output of the differential pressure gauge 58, and gas temperature and flow rate are obtained by the temperature sensor 63 and the flow rate meter (Step 12).

The pressure loss P_{L2} is ascertained from the read differential pressure, and the amount of saturated water vapor W_{H2O} and the pressure loss P_{L1} of the hydrogen gas are ascertained from gas temperature, thus the hydrogen gas concentration and the nitrogen gas concentration are calculated from the above computation (Step 13). Once the gas concentration is calculated, the nitrogen gas concentration (and the hydrogen gas concentration, if needed) is stored in the storage device (Step 14).

[4. Exhaust Shutoff Valve Drive Operation]

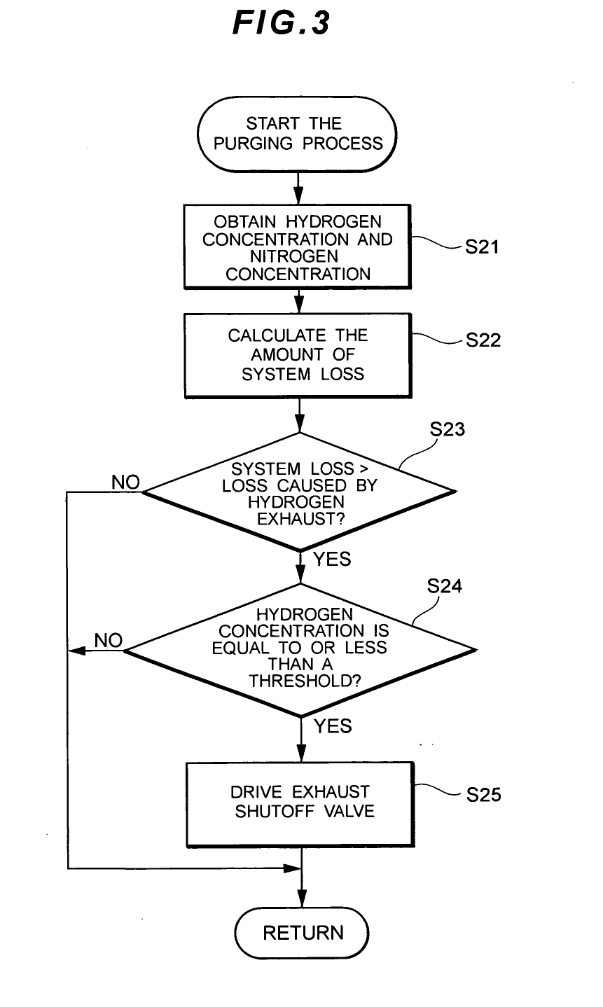

Next, an exhaust shutoff valve drive operation performed by the control section 50 in the fuel cell system according to the present embodiment is described with reference to the flowchart shown in FIG. 3.

First, the hydrogen gas concentration and the nitrogen gas concentration which are estimated in the process shown in FIG. 2 are obtained (Step 21). Next, the amount of system loss (the increased amount of the mechanical power of the hydrogen pump+the decreased amount of outputs in the fuel cell) is calculated based on the obtained nitrogen gas concentration (Step 22). When the nitrogen gas concentration increases, it is necessary to supply a large amount of gas in order to supply sufficient hydrogen gas to the fuel cell. Further, when the gas density increases, the pressure loss becomes large, and the necessary mechanical power of the hydrogen pump 37 becomes large, whereby the loss increases. Moreover, when the nitrogen gas concentration increases, the power generation efficiency in the fuel cell stack decreases. When the system loss caused by these facts is larger than the loss cased by release of the hydrogen, it is rational to release the hydrogen off-gas. In addition, when the hydrogen concentration is reduced to a level that has an adverse affect on the stability in the fuel cell, it is necessary to release the hydrogen off-gas and introduce new hydrogen gas. In Step 23 it is judged that the amount of system loss is at least the amount of loss caused by discharge of hydrogen, and in Step 24 it is judged that the hydrogen concentration is equal to or lower than a predetermined threshold. When both of these conditions are satisfied (Steps 23 and 24: YES), the exhaust shutoff valve 38 is driven to purge a fixed amount of hydrogen off-gas (Step 25). When either one of these conditions is not satisfied (Step 23 or 24: NO), the process is returned to wait for the next operation.

[5. Electrolyte Deterioration Judgment Operation]

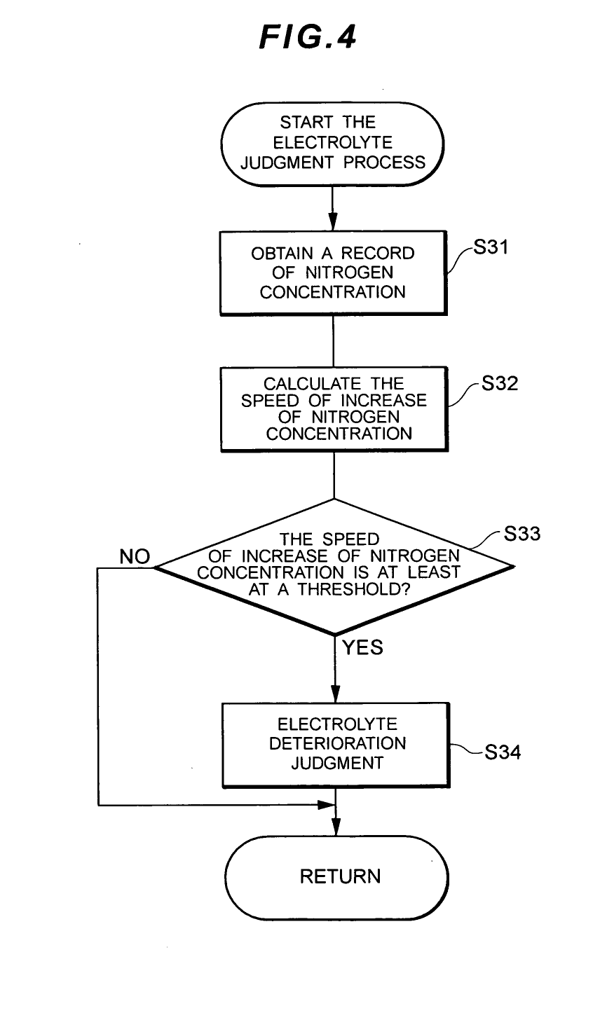

Next, an electrolyte deterioration judgment operation performed by the control section 50 in the fuel cell system according to the present embodiment is described with reference to the flowchart shown in FIG. 4.

First, a record of the nitrogen gas concentration estimated in the process shown in FIG. 2 is obtained (Step 31). Next, the speed of increase of the obtained nitrogen gas concentration is calculated (Step 32). The fact that the nitrogen gas concentration is increased rapidly means that the cross leakage of the electrolyte in the fuel cell increases and the amount of nitrogen gas penetrating from the air electrode increases, meaning that the condition of the electrolyte is deteriorated. In Step 33 it is judged that the speed of increase of the nitrogen gas concentration is at least at a predetermined threshold. When this condition is satisfied (Step 33: YES), it is determined that the electrolyte is deteriorated (Step 34), and the deterioration of the electrolyte is reported to an operator of the vehicle and the like according to need. When this condition is not satisfied (Step 33: NO), the process is returned to wait for the next operation.

By configuring the present embodiment as described above, deterioration of the electrolyte can be judged even during an operation in the fuel cell system.

1. A fuel cell system comprising an anode path composed of a supply path for supplying fuel to an anode electrode in a fuel cell stack and a discharge path for discharging the fuel from the anode electrode in the fuel cell stack,
wherein impurity gas concentration in the anode path is derived based on the differential pressure between two predetermined points in the anode path.

2. The fuel cell system according to claim 1, wherein said differential pressure is the differential pressure across a check valve in the anode path.

3. The fuel cell system according to claim 1, wherein said differential pressure is the differential pressure between two points on either side of the fuel cell stack.

4. The fuel cell system according to claim 1, wherein exhaust from the anode path is controlled based on the derived impurity gas concentration.

5. (canceled)

6. The fuel cell system according to claim 4, wherein a purge is conducted from the anode path when the derived impurity gas concentration is increased.

7. The fuel cell system according to claim 6, wherein the purge from the anode path is performed by opening a shutoff valve inside the anode path.

8. The fuel cell system according to claim 1, wherein a condition of an electrolyte in the fuel cell stack is judged based on the derived impurity gas concentration.

9. The fuel cell system according to claim 1, wherein the anode path includes a circulating path for circulating the fuel discharged from the anode electrode in the fuel cell stack back to the anode electrode.

10. A fuel cell system comprising an anode path composed of a supply path for supplying fuel to an anode electrode in a fuel cell stack and a discharge path for discharging the fuel from the anode electrode in the fuel cell stack,
wherein impurity gas concentration in the anode path is derived based on a pressure loss in the anode path.

11. The fuel cell system according to claim 10, wherein nitrogen gas concentration in the anode path is derived from the amount of change in the pressure loss in the anode path.

12. The fuel cell system according to claim 10, wherein the pressure loss in the anode path is ascertained using the amount of cross leakage produced from a cathode electrode to the anode electrode in the fuel cell stack.

13. The fuel cell system according to claim 10, wherein the pressure loss in the anode path is ascertained from three values, which are the differential pressure between two predetermined points in the anode path, pressure of fuel gas consumed in the fuel cell stack, and the amount of cross leakage produced from a cathode electrode to the anode electrode in the fuel cell stack.

14. (canceled)
